(19) United States
(12) Patent Application Publication
(10) Pub. No.: US 2006/0179616 A1
(43) Pub. Date: Aug. 17, 2006

(54) End connection for packing strap

(75) Inventors: Peter Krause, Schwelm (DE); Bernd Lewke, Remscheid (DE); Michael Muller, Herne (DE)

Correspondence Address: THE FIRM OF KARL F ROSS, 5676 RIVERDALE AVENUE, PO BOX 900, RIVERDALE (BRONX), NY, 10471-0900, US

(73) Assignee: TITAN Umreifungstechnik GmbH & Co. KG

(21) Appl. No.: 11/397,839

(22) Filed: Apr. 4, 2006

Related U.S. Application Data
(62) Division of application No. 10/726,816, filed on Dec. 2, 2003.

(30) Foreign Application Priority Data
Dec. 19, 2002 (DE) 10259598.4

(51) Int. Cl. F16L 33/00

(52) U.S. Cl. 24/20 R

(57) ABSTRACT

A strapping connection for a pair of longitudinally extending and transversely overlapping strap ends has a pair of longitudinally extending and interengaging hook formations formed as transversely pushed-out regions of the strap ends and permitting limited movement of the strap ends in one longitudinal direction. In addition the ends are formed in the pair of hook formations with transversely interengaging lock formations fitting transversely snugly together and prohibiting relative longitudinal movement of the strap ends.

### CROSS REFERENCE TO RELATED APPLICATION

This application is a division of copending application Ser. No. 10/726,816 filed 2 Dec. 2003.

### FIELD OF THE INVENTION

The present invention relates to an end connection for packing strap. More particularly this invention concerns a system for connecting the ends of metal packing strap.

### BACKGROUND OF THE INVENTION

In order to make secure a package such as a bale it is known to loop a length of steel strip tightly around the package with the ends overlapping and to connect the ends together. This connection can be simple clip or seal that is applied by a special-duty strapping machine.

Another system known from German patent document 3,546,021 eliminates the use of a separate connector part and forms the two ends with complementary hook formations that fit into each other and prevent the ends from pulling longitudinally apart. The formations are made by a tool having an interfitting die/punch assembly that presses against opposite sides of the overlapping strap ends and creates the hook formations.

While such an arrangement is extremely simple and effective, it has the considerable disadvantage that the formations can uncouple when the strap is not under tension. Thus if the package is dropped in such a manner as to momentarily compress it near the ends and in effect push the strap ends toward each other, the hook formations can disengage from each other and thereby disconnect the strap ends.

### OBJECTS OF THE INVENTION

It is therefore an object of the present invention to provide an improved end connection for a packing strap.

Another object is the provision of such an improved end connection for a packing strap which overcomes the above-given disadvantages, that is which is able to hold solidly even when not under tension.

A further object is to provide and improved system, that is method and tool, for forming the connection according to the invention.

### SUMMARY OF THE INVENTION

A strapping connection for a pair of longitudinally extending and transversely overlapping strap ends has according to the invention a pair of longitudinally extending and interengaging hook formations formed as transversely pushed-out regions of the strap ends and permitting limited movement of the strap ends in one longitudinal direction. In addition the ends are formed in the pair of hook formations with transversely interengaging lock formations fitting transversely snugly together and prohibiting relative longitudinal movement of the strap ends.

In the connection according to the invention the hook formations of each strap end are identical and point in the same direction. They fit together to prevent longitudinal separation of the two strap ends, being very strong with respect to tension in the strap. The lock formation prevents the strap ends from separating if the tension is relieved as relative longitudinal shifting in a direction opposite to their hook direction is inhibited by the lock formations.

According to the invention the strap ends are formed with two pairs of longitudinally extending and interengaging end hook formations longitudinally flanking the first-mentioned pair, and formed as transversely pushed-out regions of the strap ends permitting limited movement of the strap ends in one longitudinal direction. These end hook formation are free of the lock formations. Thus these end hook formations can bear substantially all the load from the tension in the strap, while the center hook formations with the lock formations prevent them from unhooking. In practice it is standard to cut the strap to open the package, that is the connection at the ends is permanent and not releasable.

The lock formations are formed as interfitting pyramidal or conical dimples. For best coupling, they pierce completely through one of the strap ends. When the overlying strap is actually broken through by the lock formation, the lock formations are particularly effective in preventing relative slippage and uncoupling.

Each hook formation in accordance with the invention has an end portion defined between a pair of closely spaced and longitudinally extending cuts, another end portion spaced longitudinally from the one end portion and defined between a pair of widely spaced and longitudinally extending cuts, and an intermediate portion between the end portions and formed between a pair of angled cuts each connecting a respective one of the closely spaced cuts with a respective one of the widely spaced cuts. Thus these hook formations are generally T-shaped.

The lock formations are formed between the widely spaced cuts of the hook formations. In practice, the lock formations project transversely by a distance equal at least to a thickness of the strap ends, normally twice this thickness.

The method according to the invention of joining a pair of longitudinally extending and transversely overlapping strap ends comprises the steps of pushing regions out of the overlapping strip ends to form a pair of longitudinally extending and interengaging hook formations permitting limited movement of the strap ends in one longitudinal direction. Then the pair of hook formations is deformed to form transversely interengaging lock formations fitting transversely snugly together and prohibiting relative longitudinal movement of the strap ends. As mentioned above, in accordance with the invention two further pairs of end hook formations are provided longitudinally flanking the first-mentioned pair of hook formations. Normally they are produced one after the other, first the one end hook formations with no lock formations, then the middle hook formation with the lock formations, and finally the other end hook formation with no lock formations.

The tool or apparatus for joining a pair of longitudinally extending and transversely overlapping strap ends has according to the invention an interengaging die and punch tools having wavy faces for pushing regions out of the overlapping strip ends forming the pair of longitudinally extending and interengaging hook formations and a pin set in one of the tools for forming in the pair of hook formations the transversely interengaging lock formations. The pin has a width generally equal to a width of a cavity of the die tool and an end formed with a tapered end with a flat end face. The pin is set in the punch tool and the cavity is formed with a recess in which the pin can fit loosely when the die tool and punch tool are fitted together. The pin is of hardened steel.

An advantage of this tool is that it is possible to adapt a standard strapping machine to produce the formations according to the invention. All that needs be done is replace the die/punch assembly of the strapping machine. Since these elements are standard replaceable parts, upgrading to the system of this invention is particularly easy.

### BRIEF DESCRIPTION OF THE DRAWING

The above and other objects, features, and advantages will become more readily apparent from the following description, reference being made to the accompanying drawing in which:

FIG. 1 is a side view of the end connection in accordance with the invention;

FIG. 2 is a top view of the connection of FIG. 1;

FIG. 3 is a small-scale end view showing a package being strapped with a tool according to the method of this invention;

FIGS. 4 and 5 are detail views of a part of the tool according to the invention as it forms the connection according to the invention;

FIGS. 6 and 7 are side and top views of the lower die of the tool in accordance with the invention; and

FIGS. 8 and 9 are top and side views of the upper die or punch of the tool according to the invention.

### SPECIFIC DESCRIPTION

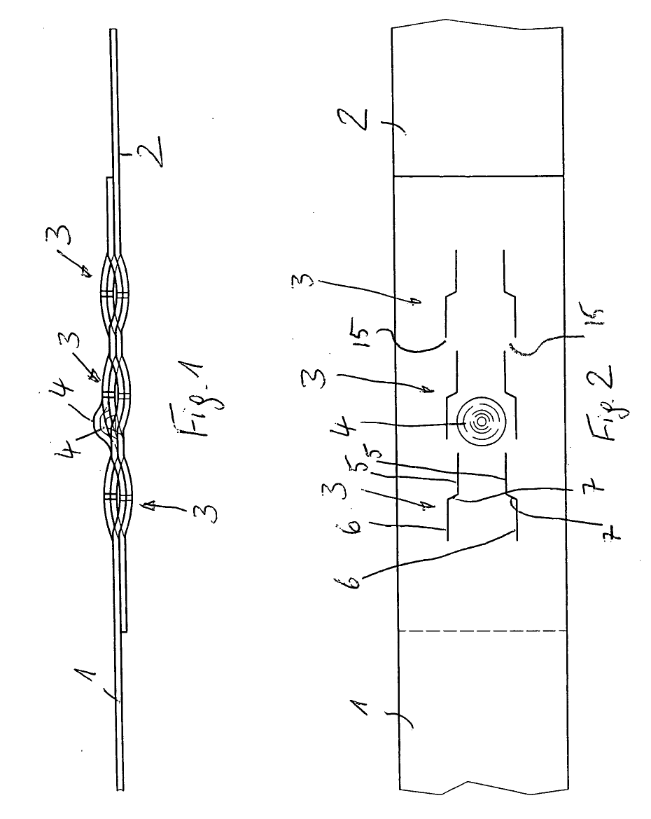

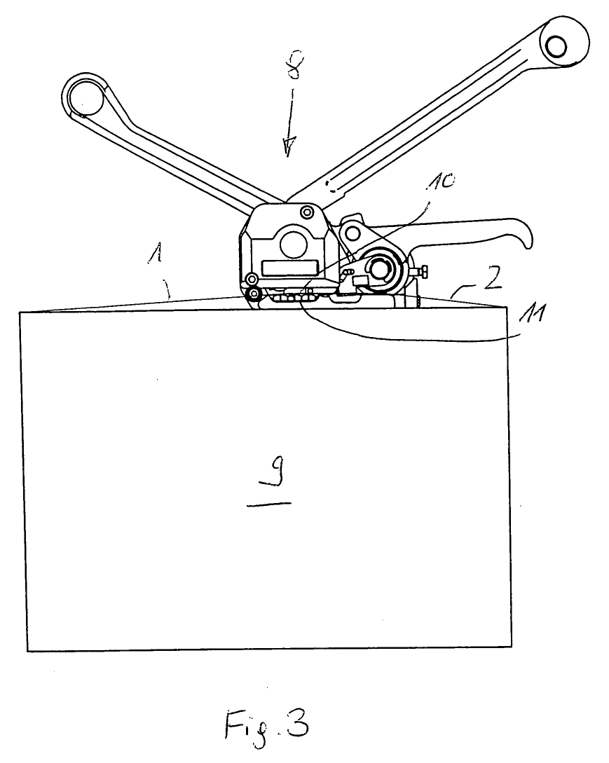

As seen in FIGS. 1 and 2, two overlapping steel-strap ends 1 and 2 are secured together at three hook formations 3 that are punched out of them. Each hook formation 3 is formed by a pair of transversely relatively closely spaced and longitudinally extending cuts 5, a pair of more widely spaced and also longitudinally extending cuts 6, and angled connector zones 7 each extending from the end of one of the cuts 4 to the end of the adjacent cut 5, leaving the ends 1 and 2 uncut at connecting webs 15 between the hook formations 3. The ends 1 and 2 are formed with a series of corrugations or bumps corresponding to the hook formations 3 so that the hook formations 3 lock the ends 1 and 2 together. The strap ends 1 and 2 are in fact as shown in FIG. 1 bent downward to both sides of each of the hook formations 3 while the hook formations 3 are bent upward so that the hook formations 3 interengage in such a manner that, if these hook formations 3 were the only ones provided on the ends 1 and 2, the two ends 1 and 2 could move limitedly longitudinally apart before locking solidly together.

According to the invention the ends 1 and 2 are further formed with interfitting dimple lock formations 4 located between the wide edges 6 of the center hook formations 3. These dimples 4 are of a height equal to about twice the thickness of the strapping. They are so deep that they in fact break through the sheet metal of the overlying strap, here the end 1. Thus they will solidly prevent the two interlocked ends 1 and 2 from shifting longitudinally relative to each other in either direction.

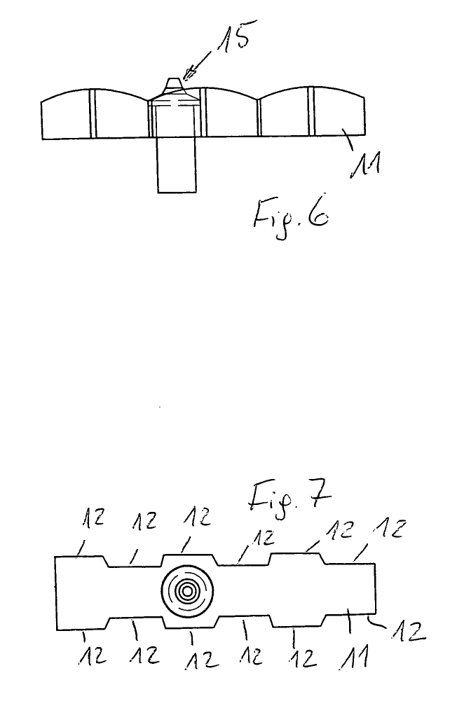

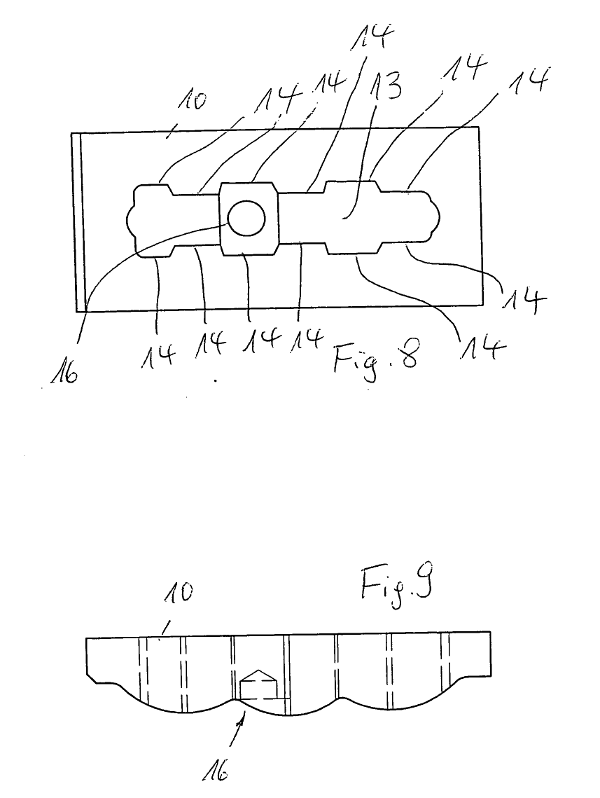

As shown in FIGS. 3 through 9, a package 9, here a bale, is secured by means of a tool 8 having a die 10 and punch 11 that together form the hook formations 3 and dimples 4. Both the die 10 and the punch 11 have wavy or corrugated faces and the die 10 is not pushed completely into the die to leave the connecting webs 15 in the ends 1 and 2 between the hook. formations 3. The punch 11 has as shown in FIG. 7 outer edges 12 that fit complementary with inner edges 14 of a cavity 13 of the die 10. In addition the punch 11 is formed with a rounded-end conical bump 15 that can fit in a cylindrical recess 16 of the die 10.

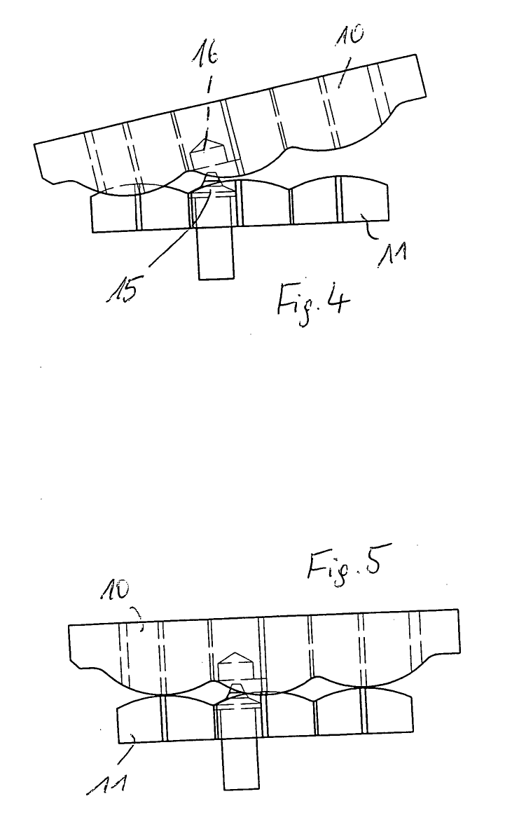

In use as shown in FIGS. 4 and 5 the die 10 and punch 11 are rocked together to first form the one pair of end hook formations 3, then the middle pair of hook formations 3 with the dimples 4, then the other pair of end hook formations 3. At the end of its rocking maneuver, after forming the third pair of end hook formations 3, the tool 8 normally cuts through the strapping to form the outer end 1. In addition the tool 8 normally also pulls the two ends 1 and 2 together before making the hook formations 3 and 4.

We claim:

1. A method of joining a pair of longitudinally extending and transversely overlapping strap ends, the method comprising the steps of:
pushing regions out of the overlapping strip ends to form a pair of longitudinally extending and interengaging hook formations permitting limited movement of the strap ends in one longitudinal direction; and
forming in the pair of hook formations transversely interengaging lock formations fitting transversely snugly together and prohibiting relative longitudinal movement of the strap ends.

2. The method defined in claim 1, further comprising the step of
forming two further pairs of end hook formations longitudinally flanking the first-mentioned pair of hook formations.

3. The method defined in claim 1 wherein the lock formations are formed as interfitting pyramidal or conical bumps.

4. The method defined in claim 1 wherein each hook formation is formed by
a pair of closely transversely spaced, adjacent, and longitudinally extending first slits,
a pair of widely transversely spaced, adjacent, and longitudinally extending second slits offset slightly longitudinally from the first slits, and
a pair of angled slits each extending from an end of a respective one of the first slits to an end of the respective second slit, the material of the straps being raised between the slits.
